(19) United States
(12) Patent Application Publication
(10) Pub. No.: US 2006/0268480 A1
(43) Pub. Date: Nov. 30, 2006

(54) 1/4" plug in-line surge suppressor for loud speakers

(76) Inventor: Charles A. Miltenberger, Mooresville, NC (US)

Correspondence Address: CHARLES A. MILTENBERGER, 190 WEEDPING SPRING DRIVE, MOORESVILLE, NC, 28115, US

(21) Appl. No.: 11/135,548

(22) Filed: May 24, 2005

(51) Int. Cl. H02H 9/00

(52) U.S. Cl. 361/58

(57) ABSTRACT

Light bulbs with certain characteristics, specifically the type known as High Positive Current Coefficient Resistors, have been used as power protection on audio speaker system crossovers for quite some time. This invention takes this component off of the internal system crossover to be used in-line externally, in a self-contained unit, outside the speaker system for simple interchangeability.

### DESCRIPTION

This unit consists of a tooled box with one ¼″ jack at one end and a ¼″ plug at the other. The light bulb is placed in the circuit in series for surge suppression.

When the light bulb receives excessive power, it lights up, dissipating power as light and heat that would otherwise potentially blow a speaker. The point at which the light bulb lights up depends on its specifications. The light bulbs used in audio systems are generally rated at between 11 and 13V and up to 2.5 Amps.

This system uses a clear logo that can be made of various translucent colors that let the light glow through it as an indicating the power protection is working.

Since the light bulb(s) may not light up until significant power is being transferred through the unit, an optional L.E.D. circuit may be used to indicate that current is flowing through the unit. The L.E.D. will light up at a lower current than the light bulb(s), thus activating sooner.

### BRIEF DESCRIPTION OF DRAWINGS

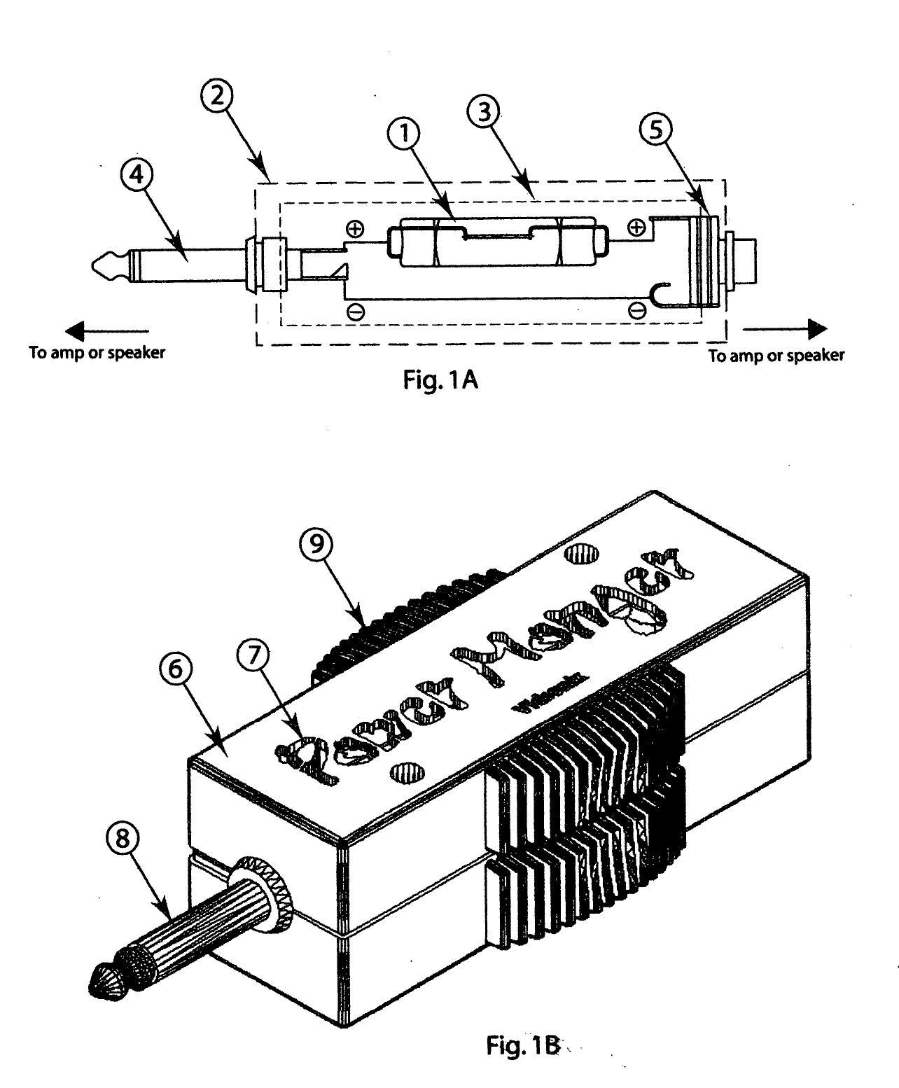

See FIG. 1A for schematic of a typical circuit and enclosure.

See FIG. 1B for a line drawings of the reference prototype.

### DETAILED DESCRIPTION OF THE INVENTION

FIG. 1A shows the typical and most basic circuit schematic. It consists of the light bulb load (1) in series between the ¼″ plug input/output (4) and the ¼″ jack input/output (5). The light bulb is surrounded by an enclosure (2). Part of this enclosure shall have a translucent material (3) so that the light from the bulb can be seen when it is active.

FIG. 1B shows a line drawing of the original preferred embodiment. The enclosure (6) is made up of a plastic material. The translucent material (7) is also plastic, and is embossed into the enclosure in the form of a logo. The input/outputs may be a number of different types, including the ¼″ phone plug (8) shown here. In addition, this preferred embodiments using a heat sink (9) in the enclosure to help dissipate heat. This is optional.

Conclusions, Ramifications and Scope of Invention

As previously described, this enclosure and circuit provide portable and interchangeable power protection of loudspeakers and all other audio transducers. The unit is small and compact, and replacement with a disabled or burned out unit is quick and easy. Multiple units may be daisy-chained, or connected in series, to provide additional and scalable power protection. This unit can be connected to any existing loudspeaker cabinet or system and provide added power protection.

Since certain changes may be made in the foregoing disclosure without departing from the scope of the claims, it is intended that all matter contained in the foregoing specification or shown in the accompanying drawings be interpreted as an exemplification of one preferred embodiment thereof and not in a limiting sense.

### BACKGROUND OF THE INVENTION

Light bulbs and lamps that can light up via an audio AC current have been used in loudspeaker circuit protection for many years. U.S. Pat. No. 2,237,448 (Wemer, 1941) describes the advantages of using filament bulbs for power protection. Over the years, a number of patents have since incorporated light bulbs as loads or indicators into their protection circuit design (U.S. Pat. No. 3,890,465, Kaizu; U.S. Pat. No. 4,122,507, Queen; U.S. Pat. No. 4,864,624 Tichy; U.S. Pat. No. 4,932,060, Schreiber; U.S. Pat. No. 6,657,435). Still others indicate an optional use of a light bulb in their loudspeaker protection circuit (U.S. Pat. No. 6,647,120, Howze). Several other patents include designs for overload protection circuit using no light bulbs or lamps (U.S. Pat. No. 5,577,126, Klippel) and even offer disadvantages of using a light bulb (U.S. Pat. No. 6,201,680, Tokatian).

The light bulb serves as a nonlinear resistive element that absorbs and dissipates power as light and heat when the signal from an amp reaches a certain level, thus limiting the power that the actual loudspeaker receives. This transient limiting and dynamic range compression effect protects the speaker from overpowering, and thus also has the effect of extending the speaker's lifespan. In addition, the inherent lag of the typical tungsten coil used in these bulbs minimizes it effect on signal distortion.

Light bulbs are susceptible to burning out at excessive currents or after their lifespan has been reached. This has always been a limitation of using light bulbs because the open circuit renders the rest of the circuit dead. The light bulb would need to be replaced for the speaker to function. This involves the speaker system being opened and/or disassembled, the old light bulbs de-soldered and removed, and a new light bulb soldered and installed, which can be very time consuming. This invention takes the light bulb physically out of the speaker system crossover itself and into an in-line, portable unit that can be inserted or replaced with ease.

In addition, whereas normally this light bulb would not be seen in a loudspeaker system, this invention purposely makes its light visible so that one can see the amount of power absorption taking place. This is done by using a translucent material in the enclosure housing.

Description

This unit consists of a tooled box with one ¼″ jack at one end and a ¼″ plug at the other. The light bulb is placed in the circuit in series for surge suppression.

When the light bulb receives excessive power, it lights up, dissipating power as light and heat that would otherwise potentially blow a speaker. The point at which the light bulb lights up depends on its specifications. The light bulbs used in audio systems are generally rated at between 11 and 13V and up to 2.5 Amps.

This system uses a clear logo that can be made of various translucent colors that let the light glow through it as an indicating the power protection is working.

Since the light bulb(s) may not light up until significant power is being transferred through the unit, an optional L.E.D. circuit may be used to indicate that current is flowing through the unit. The L.E.D. will light up at a lower current than the light bulb(s), thus activating sooner.

### BRIEF DESCRIPTION OF DRAWINGS

See FIG. 1A for schematic of a typical circuit and enclosure.

See FIG. 1B for a line drawings of the reference prototype.

### DETAILED DESCRIPTION OF THE INVENTION

FIG. 1A shows the typical and most basic circuit schematic. It consists of the light bulb load (1) in series between the ¼″ plug input/output (4) and the ¼″ jack input/output (5). The light bulb is surrounded by an enclosure (2). Part of this enclosure shall have a translucent material (3) so that the light from the bulb can be seen when it is active.

FIG. 1B shows a line drawing of the original preferred embodiment. The enclosure (6) is made up of a plastic material. The translucent material (7) is also plastic, and is embossed into the enclosure in the form of a logo. The input/outputs may be a number of different types, including the ¼″ phone plug (8) shown here. In addition, this preferred embodiments using a heat sink (9) in the enclosure to help dissipate heat. This is optional.

I claim:

1. A portable, self-contained and enclosed loudspeaker protection circuit, comprising of; a circuit of any number of light bulbs, in parallel or in series as a means of limiting the power input and transient response of a loudspeaker; and, input and output connectors for connecting the unit in series with audio cable.

2. The enclosed protection circuit of claim 1, wherein said unit contains a transparent material, colored or non-colored in which light emitted from the light bulb can pass through as an indication of the power being used by the light bulb(s).

3. The enclosed protection circuit of claim 2, wherein said unit uses an L.E.D. circuit for low level power indication.
